(19) United States
(12) Patent Application Publication
(10) Pub. No.: US 2025/0140124 A1
(43) Pub. Date: May 1, 2025

(54) GROUNDED VISUAL QUESTION ANSWERING METHOD BASED ON DAYNAMIC TWO-LEVEL VISUAL INFORMATION FUSION

(71) Applicant: Dalian University, Dalian (CN)

(72) Inventors: Dongsheng ZHOU, Dalian (CN); Yue Zhang, Dalian (CN); Wanshu Fan, Dalian (CN); Chao Che, Dalian (CN)

(21) Appl. No.: 18/675,445

(22) Filed: May 28, 2024

Related U.S. Application Data
(63) Continuation of application No. PCT/CN2023/128345, filed on Oct. 31, 2023.

(51) Int. Cl. G09B 5/02; G06V 10/86

(52) U.S. Cl. CPC G09B 5/02; G06V 10/86

(57) ABSTRACT

A ground visual question-answering method based on dynamic dual-level visual information fusion includes using a dual-level multiscale network, which is divided into language-guided pixel-level features and region-level features. These two scale branches are combined to predict the final textual answer and ground answer. Furthermore, a question-guided dynamic region-level feature localization network is proposed to locate visual information guided by the question and adaptively assign masks of different sizes to ground answers, thereby enhancing the accuracy of locating and segmenting small targets. Additionally, a cross-modal aggregation module is designed to fuse features from both levels, enhancing the fusion of pixel-level and region-level features to improve the segmentation effect of ground answer masks' edges. The ground visual question-answering system built by the language-guided adaptive dual-level feature fusion network in this invention can effectively improve the accuracy of the entire model while answering questions and generating answer ground masks simultaneously.

### FIELD OF THE INVENTION

The present invention belongs to the field of computer vision and natural language processing technology, and specifically relates to a grounded visual question answering method based on dynamic two-level visual information fusion.

### BACKGROUND OF THE INVENTION

In recent years, VQA (Visual Question Answering) technology has developed rapidly, and there are more and more practical application scenarios, such as answering questions from visually impaired patients or helping radiologists diagnose fatal diseases at an early stage, as well as human-computer interaction. As these systems become more sophisticated, the accuracy of a system that produces good answers will not be sufficient, and the validity of the answers will also be important for a variety of studies and applications. By considering the inference mechanism of the model, it is possible to provide explainable support for the answer to a certain extent. An ideal VQA system for such purposes should not only generate accurate answers, but also provide a mechanism for verifying answers.

However, the traditional VQA usually only outputs the final text answer and lacks the verification of visual evidence, so in recent years, there have been works to try to solve this problem, such as the MAC-CAPS method (capsule-based weakly supervised grounded visual question answering), which proposes to give a visual attention map at the same time as the text answer, in order to better evaluate the accuracy of the system's positioning answer. Similar methods include LXMERT (transformer-based cross-modal encoder) and DCAMN (double-capsule attention mask network with mutual learning function for visual question answering) that generate text answers and output the grounded answer area in the corresponding image region. However, these methods usually output an attention map or box related to the problem to show the ground-related area, and if an educated image grounding answer mask is provided when answering a visual question, it can be directly verified that the answer obtained is convincing, which can make the VQA system more reliable. At the same time, from the perspective of application, obtaining an image grounding mask can expand more applications, such as separating relevant content from the background in the face of questions from visually impaired people, blurring the background to protect privacy, or magnifying the relevant visual area, so that users with low vision can find the information they want faster.

Therefore, the answer grounding task is proposed, which is different from the conventional VQA task, which starts from the practical application of the visually impaired, and aims to output the mask map of the visual area corresponding to the answer while answering the text answer. For this task, DAVI (Answer Grounding Based on Dual Visual Language Interaction) is a combination of two pre-trained large models, BLIP (Guided Language Image Pre-training to Achieve Unified Visual Language Understanding and Generation) and VIT (Multimodal Framework Based on Visual and Language Research), including two encoders and two decoders combine the text-image segmentation task model and the vision-to-language generation task model, but in fact, it is equivalent to separating the two interrelated tasks of generating text answers and output ground masks into two independent tasks. However, the newly published DDTN (Grounding Visual Answer Based on Dual Decoder Transformer Network) does not use a large-scale pre-trained model, but the segmentation effect is much lower than that of DAVT.

### BRIEF SUMMARY OF THE INVENTION

In view of the above-mentioned problems existing in the prior art, the invention proposes a grounded visual question answering method based on dynamic two-level visual information fusion, which can also achieve a relatively good segmentation effect without being based on a large-scale pre-trained model, and realizes the output of two answer modes under the condition of an encoder and a decoder, so that the interaction between the two modalities can be better realized.

In order to achieve the above purpose, the technical scheme of the present invention is:

The grounded visual question answering method based on dynamic two-level visual information fusion includes the following steps:

Step 1: As shown in FIG. 1, the present invention adopts a problem-guided regional-level dynamic multi-scale method to locate and segment the grounded answer, and a language-guided regional-level feature module QGDR is designed, which is composed of a cross-attention module and a spatial attention module, and finally obtains a region-level mask prediction feature Fᵢ∈Fₜ, Fₛ, Fₘ, Fₗ with a resolution from small to large; wherein Fₜ, Fₛ, Fₘ, Fₗ are four types of regional feature hierarchies, and the spatial resolution from Fₜ to Fₗ is increased by two times layer by layer;

Step 2: In order to reduce computational overhead while maintaining performance, a dynamic approach is adopted to adaptively assign a mask of the appropriate resolution size to each anchored object, and budget limits are imposed on resource consumption. The QGDR output has four different switching states, corresponding to four different mask resolutions, namely [14×14,28×28,56×56,112×112];

Step 3: In order to better integrate the features of the two levels, a cross-modal multi-scale fusion module FPA is designed to aggregate the feature Fi and Pi output by the language-guided pixel-level feature module PWAM and the language-guided region-level feature module QGDR;

Step 4: construct an information flow between each level of the language-guided pixel-level feature module PWAM and the language-guided regional-level feature module QGDR, perform hierarchical and step-by-step decoding, and finally obtain the grounding answer and the text answer obtained by the image segmentation decoder and the text decoder;

Step 5: load the model in step 4, input the required image and its corresponding question into the trained grounded visual question answering model, and obtain the corresponding grounded answer and text answer;

Based on the above scheme, the method adopts multi-scale information fusion, which can better understand and process visual information at different scales, which is helpful to improve the understanding and localization of complex scenes, thereby improving the accuracy of question answering. In this method, an adaptive resolution mask allocation is adopted, which dynamically allocates a mask of appropriate resolution size according to the needs of each positioning object, which can improve the efficiency of resource utilization while maintaining high-resolution processing of critical areas. By introducing the cross-modal multi-scale fusion module, the multi-scale aggregation of language-guided pixel-level features and region-level features can better combine text information and image information, and improve the comprehension of questions and the ability to generate answers. The hierarchical and step-by-step decoding method is used to decode the information from pixel-level features to region-level features and then to the final answer, which helps to better capture the detailed information in the image and associate it with the question, which improves the accuracy of Q&A. Multiple loss functions, including mask loss, edge loss, budget constraints, and text loss, are used to consider different aspects of the goal to better train the model and improve the performance of the model. This method can be applied to grounded visual question answering, providing an efficient and accurate method for machines to understand images and answer questions, and has the potential to be applied to various fields, such as autonomous driving, medical image analysis, image retrieval, etc.

Further, step 1 specifically comprises:

Step 1.1: First, the ROI-aligned regional features Zᵢ extracted from the swin-transformer are averaged and pooled to Z̅ₗ, combined with the problem feature Kᵢ extracted from BERT. Input Z̅ₗ and Kᵢ into cross-modal attention, which can be regarded as injecting the word attention in the problem into different visual channels to guide visual localization and promote the complementarity and enhancement of multimodal information. where T represents the transpose operation, after two linear transformations, the specific formula is as follows:

$${Q}_{i} = softmax ( \frac{\overline{{Z}_{i}} \overline{{K}_{i}^{T}}}{\sqrt{{D}_{i}}} ) \hat{{K}_{l}} A = π {r}^{2} \qquad ( 1 )$$

Where Qᵢ represents the attention weight, dᵢ represents the length of the Z̅ᵢ and K̅ᵢ vectors, and \hat{K}ₗ represents the vector generated by the linear transformation of the problem features;

Step 1.2: Perform a global pooling operation on the obtained Qᵢ to obtain the information weight Q̅ᵢ∈R^{C×1×1}. It is fed into the attention module SE-block to weight the different channels of visual information used for screening. Then, several convolutional and fully connected layers are used for classification, and the region-level mask prediction feature Fᵢ of different sizes is obtained. The specific formula is as follows:

$${F}_{i} = ℱ ( conv ( {F}_{ex} ( \overline{{Q}_{l}} , w ) ) ) \qquad ( 2 )$$

Where [symbol] represents the Flattehen operation, Fₑₓ represents the operation in the SE-block block, and w represents the weight; the specific formula for the Fₑₓ operation is as follows:

$${F}_{e x} = δ ( {w}_{2} ρ ( {w}_{1} \overline{{Q}_{l}} ) ) \qquad ( 3 )$$

Where δ represents the sigmoid function, ρ represents the ReLU function,

$${w}_{1} ∈ {R}^{\frac{C}{r} \times C} and {w}_{2} ∈ {R}^{C \times \frac{C}{r}} . {R}^{\frac{C}{r} \times C}$$

represents the weight matrix dimension.

Further, the step 2 specifically comprises:

The QGDR module is actually a lightweight classifier designed to select the best mask resolution from k candidate targets at different scales for accurate localization and segmentation of the grounded answer with minimal resource cost. QGDR divides Fᵢ into four categories: regional feature hierarchy Fₜ, Fₛ, Fₘ, Fₗ, and the spatial resolution is increased by two times from Fₜ to Fₗ. And by performing the softmax operation, the probability vector is output ϵ^{k}=[ϵ¹, . . . , ϵ^{k}]. Each element of this probability vector represents the probability that the corresponding candidate resolution will be selected. The soft output ϵ^{k} of the QGDR should be converted into a single thermal prediction, expressed as H=[h₁, . . . , hₖ]. This process can be accomplished by discrete sampling, followed by the backpropagation of the gradient using Gumbel-Softmax to update the QGDR. The specific formula is as follows:

$${h}_{i} = \frac{exp ( ( log {ε}^{k} + {g}_{i ) / τ )}}{{Σ}_{{k}^{′}} exp ( ( log {ε}^{{k}^{′}} + {g}_{i ) / τ )}} \qquad ( 4 )$$

Where τ is a parameter, and when τ is close to 0, Gumbel-softmax is close to the one-hot. gᵢ denotes the Gumbel distribution, and ϵ^{k′} denotes k′ discrete probability vectors.

Further, the step 3 specifically comprises:

After being processed by the question-guided Pixel-Level Feature Module (PWAM) and the question-guided Region-Level Feature Module (QGDR), the modal fusion features Pᵢ ∈R^{C}^{ᵢ}^{×H}^{ᵢ}^{×W}^{ᵢ} and Fᵢ ∈ R^{C×H×W} are obtained. Next, the output of these two modules needs to be aggre-gated at multiple scales. Due to the upsampling and ROI pooling operations in these two modules, there exists spatial misalignment between Fᵢ and Pᵢ. In order to enhance the segmentation performance of boundary regions, this paper proposes a module called FPA that adaptively aggregates multi-scale features. As shown in the FIG. 1, FPA consists of a deformable convolution and a dynamic convolu-tion. Firstly, Fᵢ is upsampled through deconvolution. Then, Fᵢ is concatenated with Pᵢ, and the concatenated features are fed into a 3×3 convolution to obtain the offset mapping, represented by ΔO. Finally, Fᵢ is aligned with Pᵢ using the learned offset value o, and the position of Fᵢ′s out-put from QGDR is adjusted through deformable convolu-tion (Deform conv1) to better align with the output Pᵢ from PWAM. The specific formula is as follows:

$${O}_{i} = Φ [ conv ( ρ ( {F}_{i} ) ‖ {P}_{i} ) ] \qquad ( 5 )$$

Where ρ denotes the Deconv operation, Φ denotes the Deform conv1 operation, and ∥ is the concatenate operation.

Step 3.2: After the Deform conv1 operation, Oᵢ is added to Pᵢ. Then after 1×1 convolution the output channel is realized as C. Finally, it is passed through CondConv which is similar to the attention mechanism and it serves to pay more attention to the salient parts of the object. The transmembrane multi-scale aggregation module, The FPA is inserted into different stages of the Swin-Transformer de-coding and plays a crucial role in improving grounded answer mask prediction. The specific formula is as follows:

$${Y}_{i} = ψ ( c o n {v}_{1 \times 1} ( {O}_{i} + {P}_{i} ) ) \qquad ( 6 )$$

Where Yᵢ denotes the regional feature and Ψ denotes the CondConv operation.

Further, the step 4 is specifically as follows:

The QGDR dynamically locates the grounded answer in the image by a language-guided image and provides a grounded answer mask assigned different resolutions for different aggregation stages. The cost of computing resources is reduced while ensuring accuracy, so three loss functions are used to train the dynamic multi-scale module.

Step 4.1: Given a VQA instance, we first predict its mask switching state H=[h₁, . . . , hₖ] by QGDR, and obtain a group of mask prediction maps at K different resolutions {mᵢ¹, . . . , mᵢ^{k}} by passing this instance through different stages of decoding. The mask loss function is defined as follows:

$${ℒ}_{m} = {\sum }_{i = 1}^{N} {\sum }_{k = 1}^{K} {h}_{i} 𝒞 ( {m}_{i}^{k} , {\hat{m}}_{i} ) \qquad ( 8 )$$

Where N denotes N different instances, mᵢ^{k} denotes the k-th mask prediction ground truth answer, and \hat{m}ᵢ represents its corresponding ground truth mask grid, h; is the indicator for whether the k-th mask resolution is selected as the output resolution. [symbol] is defined as the binary cross-entropy loss in this paper.

Step 4.2: The second is edge loss, for the masks generated by QGDR, dynamic selection is performed. It is commonly believed that the size of mask loss can be used as a measure of mask quality. However, the mask losses generated on different masks are very close, making it difficult to distinguish mask quality. In contrast, there is a larger difference in edge loss generated by masks of different resolutions, which can better reflect the quality of the mask. Therefore, this paper adopts edge loss as a measure of mask quality. Given the output F=[f₁, . . . , fₖ] of QGDR and the edge mapping at different resolutions represented as {eᵢ¹, . . . , eᵢ^{k}}, the edge loss is defined as follows:

$${ℒ}_{e} = {\sum }_{i = 1}^{N} {\sum }_{k = 1}^{K} {h}_{i} 𝒞 ( {e}_{i}^{k} , {\hat{e}}_{i} ) \qquad ( 8 )$$

Where eᵢ^{k} denotes the ground-truth answer edge, which is generated by first applying the Laplacian operator on the ground-truth answer mask \hat{m}ᵢ to obtain a soft edge map, and then converting it into a binary edge map by thresholding.

Step 4.3: The QGDR module is optimized by the edge loss in formula 4.2, but there is a problem with the model converging to a suboptimal solution, where all instances are segmented with the highest resolution mask because it contains more detailed information and thus results in minimal prediction loss. However, experiments have proven that not all samples require segmentation with the maximum mask. In order to avoid the aforementioned problem, improve model efficiency, and reduce computational complexity, this paper adopts budget constraints to train QGDR. Specifically, let C represent the corresponding computational cost for the selected mask resolution. A penalty is added to the model when the expected deviation (E(C)) from the current batch data exceeds the target deviation (represented as Cₜ) in order to control the computational cost.

$${ℒ}_{b} = max ( \frac{E ( C )}{{C}_{t}} - 1 , 0 ) \qquad ( 11 )$$

Step 4.4: The final total objective function for the grounded answer branch is obtained as follows, where λ₁ and λ₂ are the trade-off hyper-parameters:

$${ℒ}_{t} = {ℒ}_{m} + {λ}_{1} {ℒ}_{e} + {λ}_{2} {ℒ}_{b} \qquad ( 12 )$$

Finally, the question features and visual features are combined through the elemental product for classification via the Softmax function. This network is trained with binary cross entropy loss function for both text answers and PWAM.

Further, the step 5 specifically comprises:

Load the model best trained in step 4, input images and corresponding questions into the model, and output answers and corresponding evaluation indicators.

Beneficial effects of the present invention: The invention proposes a grounded visual question answering method based on dynamic two-level visual information fusion, which constructs a multi-level direct flow from pixel-level features to region-level features, thereby promoting the complementary information aggregation of multi-level features. Specifically, the present invention provides a problem-oriented dynamic region-level module, which can effectively locate region-level objects according to the problem, and dynamically select masks of different resolutions, so as to realize the characteristics of the language guidance object level multi-scale feature fusion. In addition, the invention proposes a cross-modal multi-scale fusion module, which is guided by the language in the image, adaptively aggregates pixel-level information and region-level content, so as to realize the interaction and fusion of multi-modal information from different levels, realizes high-quality information interaction, and effectively improves the accuracy of the whole model.

### BRIEF DESCRIPTION OF THE DRAWINGS

FIG. 1 is a framework diagram of the dynamic dual-level vision transformer fusion network for answer grounding in visual question answering.

### DETAILED DESCRIPTION OF THE PREFERRED EMBODIMENTS

The embodiments of the present invention are implemented under the premise that the technical scheme of the present invention is given, and a detailed embodiment and a specific operation process are given, but the scope of protection of the present invention is not limited to the following embodiments.

This invention provides a grounding visual question answering method based on dynamic dual-level visual information fusion, which constructs a grounding visual question answering system through a dual-level multiscale network, namely divided into language-guided pixel-level features and region-level features. These two scale branches are combined for the final text answer and grounding answer prediction. Additionally, a question-guided dynamic region-level feature localization network is proposed to locate visual information guided by questions and adaptively allocate masks of different sizes to the grounding answers, improving the accuracy of locating and segmenting small targets. Furthermore, a cross-modal aggregation module is designed to fuse features from both levels, enhancing the feature fusion between pixel-level and region-level features to improve the segmentation effect of grounding answer masks' edges. The grounding visual question answering system built by the language-guided adaptive dual-level feature fusion network in this invention can generate answer grounding masks while answering questions, effectively improving the overall model accuracy.

### Example 1

The embodiment takes the Windows system as the development environment, Pycharm as the development platform, and Python as the development language, and adopts the grounded visual question answering method based on dynamic two-level visual information fusion of the present invention to complete the grounding answer prediction of the picture taken by the visually impaired person and its related questions.

In this embodiment, the visual question answering method based on dynamic dual-level visual information fusion comprises the following steps:

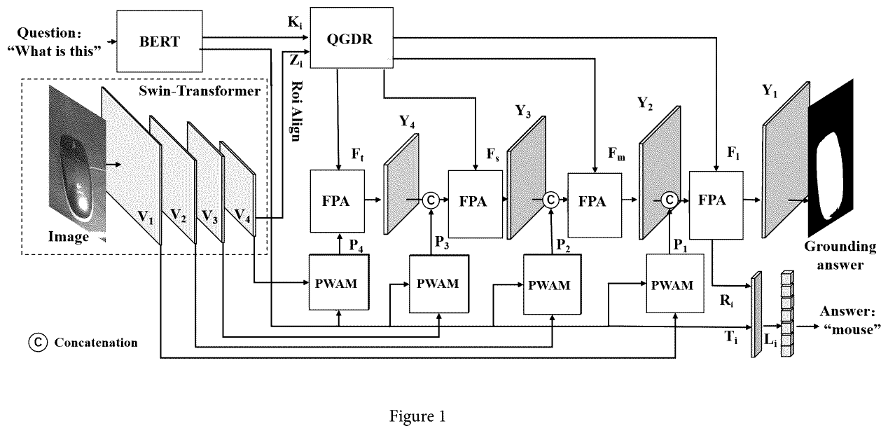

Step 1: Load the pre-trained weights of Swin Transformer and BERT encoders in the DDVT network into the grounding visual question answering network as illustrated in FIG. 1.

Step 2: Input the ‘image-question-grounded answer’ pairs from the training set into the grounding visual question answering network from Step 1 for training. Step 3: Input the required images along with their corresponding questions,

load the network model saved after training in Step 2, and obtain the corresponding grounding answers as well as the respective evaluation metrics. This invention utilizes the Intersection over Union (IoU), which is the overlap area between the model's predicted segmentation and the ground truth segmentation divided by the union area of the predicted segmentation and the ground truth segmentation, as the evaluation metric. Its calculation can be represented by formula (16), where Sᵢ and Sᵤ represent the predicted segmentation answer and the ground truth label answer, respectively.

$$IOU = \frac{{S}_{i} ⋂ {S}_{u}}{{S}_{i} ⋃ {S}_{u}} \qquad ( 16 )$$

Based on the above steps, this invention compares the LXMTRT model, Mac-Caps model, UNIFIED model, DDVT model, and other models such as MCAN. From Table 1, it can be observed that the method proposed in this invention generally outperforms other methods in terms of accuracy on two commonly used test sets.

TABLE 1
Results of the Comparison with state-of-the-art methods on the
VizWizGround test set and VQS val set.

| | | IOU | |
|---|---|---|---|
| Methods | [symbol] | VizWizGroundVQA | VQS |
| LXMTRT | [symbol] | 22.09 | — |
| Mac-Caps | [symbol] | 27.3 | — |
| UNIFIED | [symbol] | 54.7 | — |
| DDVT | [symbol] | 53.4 | — |
| DFAF | [symbol] | — | 17.5 |
| MCAN | [symbol] | — | 23.91 |
| BUTD | [symbol] | — | 33.97 |
| SDCAM | [symbol] | — | 37.93 |
| DDVT(ours) | [symbol] | 65.3 | 43.47 |

The foregoing description of specific exemplary embodiments of the present invention is provided for the purpose of illustration and explanation. These descriptions are not intended to limit the invention to the precise forms disclosed, and it is apparent that many changes and variations can be made based on the teachings provided above. The purpose of selecting and describing exemplary embodiments is to explain the specific principles of the invention and its practical application, thereby enabling those skilled in the art to implement and utilize various different exemplary embodiments of the invention, as well as various different choices and changes. The scope of the invention is defined by the claims and their equivalents.

What is claimed is:

1. A ground visual question-answering method based on dynamic dual-level visual information fusion, characterized by the following steps.
Step 1: Using a question-guided dynamic multi-scale approach for locating and segmenting ground answers, the method involves designing a language-guided region-level feature module, QGDR. QGDR consists of cross-attention and spatial attention modules, ultimately yielding region-level mask prediction features denoted as Fᵢ ∈ Fₜ, Fₛ, Fₘ, Fₗ, with resolution increasing from small to large. Within this structure, Fₜ, Fₛ, Fₘ, Fₗ represent four classes of region features, with spatial resolution doubling at each successive level.
Step 2: Using a dynamic method to adaptively assign appropriate mask resolutions to each localized object while budgeting resource consumption; QGDR outputs four different switch states corresponding to four different mask resolutions, namely [14×14, 28×28, 56×56, 112×112].
Step 3: Design a cross-modal multi-scale fusion module, FPA, to aggregate features from the language-guided pixel-level feature module, PWAM, and the language-guided region-level feature module, QGDR, at multiple scales.
Step 4: Between each level of the language-guided pixel-level feature module (PWAM) and the language-guided region-level feature module (QGDR), construct information flows to perform hierarchical decoding. Ultimately, the ground answers are obtained by the image segmentation decoder, while the textual answers are obtained by the text decoder. The ground visual question-answering model, composed of dual-level feature branches, is trained using a combination of mask loss, edge loss, budget constraints, and text loss.
Step 5: Load the model from step 4, input the required images along with their corresponding questions into the trained ground visual question-answering model, and obtain the corresponding ground answers and textual answers.

2. According to claim 1, the ground visual question-answering method based on dynamic dual-level visual information fusion is characterized by step 1, which specifically includes the question-guided dynamic multi-scale approach at the region level.
Step 1.1: Firstly, the region features Zᵢ extracted from the Swin Transformer for ROI alignment are subjected to average pooling to obtain Z̅ₗ. Then, combined with the question features Kᵢ extracted from BERT, Z̅ₗ and Kᵢ are input into the cross-modal attention. Here, T represents the transpose operation. After two linear transformations, the specific formula is as follows.
$${Q}_{i} = soft max ( \frac{{\overline{Z}}_{i} {\overline{K}}_{i}^{T}}{\sqrt{{d}_{i}}} ) {\hat{K}}_{i} \qquad ( 1 )$$
Where Qᵢ represents attention weights; dᵢ represents the length of vectors Z̅ᵢ and K̅ᵢ; \hat{K}ₗ represents the vector generated by linear transformation of the question features.
Step 1.2: Perform global pooling on the obtained Qᵢ to obtain information weights Q̅ₗ, which are then fed into the attention module SE-block to weight different channels of visual information used for filtering. Then, use several convolutional and fully connected layers for classification, resulting in region-level mask prediction features Fᵢof different sizes. The specific formula is as follows.
$${F}_{i} = ℱ ( conv ( {F}_{ex} ( {\overline{Q}}_{i} , w ) ) ) \qquad ( 2 )$$
In the equation, [symbol] represents the Flatten operation, Fₑₓ represents the operation within the SE-block module, and w represents the weights.
The specific formula for the operation F1 is as follows.
$${F}_{ex} = δ ( {w}_{2} ρ ( {w}_{1} {\overline{Q}}_{1} ) ) \qquad ( 3 )$$
Where δ represents the sigmoid function, ρ represents the ReLU function, w₁ ∈
$${R}^{\frac{C}{r} \times C} and {w}_{2} ∈ {R}^{C \times \frac{C}{r}} ; {R}^{\frac{C}{r} \times C}$$
represent the dimensions of the weight matrix.

3. According to claim 1, the ground visual question-answering method based on dynamic dual-level visual information fusion is characterized by step 2, which involves dynamically adapting to allocate appropriately sized masks for each localized object. This includes:
QGDR is a lightweight classifier that selects the optimal mask resolution from k different scales of candidate objects. QGDR divides Fᵢ into a hierarchical structure of four classes of region features, Fₜ, Fₛ, Fₘ, Fₗ, where the spatial resolution increases by a factor of two from Fₜ to Fₗ. It computes a probability vector, ϵ^{k}=[ϵ¹, . . . , ϵ^{k}]. through softmax operation, where each element of the probability vector represents the probability of selecting the corresponding candidate resolution. QGDR's soft output, ϵ^{k}=[ϵ¹, . . . , ϵ^{k}], is transformed into a one-hot prediction, denoted as H=[h₁, . . . , hₖ], achieved through discrete sampling. Then, QGDR is updated via gradient backpropagation using Gumbel-Softmax. The specific formula is as follows.
$${h}_{i} = \frac{exp ( ( log {ε}^{k} + {g}_{i} ) / τ )}{{\sum }_{{k}^{′}} exp ( ( log {ε}^{{k}^{′}} + {g}_{i} ) / τ )} \qquad ( 4 )$$
In the equation, τ is a parameter; as it approaches 0, Gumbel-Softmax approaches one-hot encoding; gᵢ represents the Gumbel distribution; ϵ^{k′} represents k′ discrete probability vectors.

4. According to claim 1, the ground visual question-answering method based on dynamic dual-level visual information fusion is characterized by step 3, which specifically includes.
Step 3.1: After processing the modal information of images and questions through the language-guided pixel-level feature module (PWAM) and the language-guided region-level feature module (QGDR), cross-modal fusion features Pᵢ ∈R^{C}^{ᵢ}^{×H}^{ᵢ}^{×W}^{ᵢ} and Fᵢ ∈R^{C×H×W} are obtained. Next, the outputs of these two modules are aggregated at multiple scales. A cross-modal multi-scale fusion module, FPA, is designed to adaptively aggregate multi-scale features. FPA consists of a deformable convolution and a dynamic convolution. Firstly, Fᵢ undergoes upsampling through deconvolution (Deconv). Then, Fᵢ is concatenated with Pᵢ, and the concatenated features are passed through a 3×3 convolution to obtain the offset mapping, denoted as ΔO. Finally, using the learned offset o, Fᵢ is aligned with Pᵢ. The position of the output Fᵢ from QGDR is adjusted by deformable convolution (deform conv1) to align with the output Pᵢ from PWAM. The specific formula is as follows.
$${O}_{i} = ∅ [ conv ( ρ ( {F}_{i} ) ‖ {P}_{i} ) ] \qquad ( 5 )$$
In the equation, ρ represents the Deconv operation, Φ represents the deform conv1 operation, and ∥ is the concatenation operation.
Step 3.2: After the deformable convolution operation, Oᵢ is added to Pᵢ. Then, a 1×1 convolution is applied to achieve an output channel of C. Finally, through conditional convolution (CondConv), the cross-modal multi-scale fusion module FPA is inserted into different stages of the Swin Transformer decoder. The specific formula is as follows.
$${Y}_{i} = ψ ( {conv}_{1 \times 1} ( {O}_{i} + {P}_{i} ) ) \qquad ( 6 )$$
In the equation, Yᵢ represents the region features, and Ψ represents the CondConv operation.

5. According to claim 4, the ground visual question-answering method based on dynamic dual-level visual information fusion is characterized by the specific mask loss in step 4 as follows: Given a VQA instance, firstly, different resolution mask switching states H=[h₁, . . . , hₖ] are predicted by QGDR, and then they are transmitted through the fusion of the FPA module to different stages of the decoding end, obtaining a set of K mask prediction images {mᵢ¹, . . . , mᵢ^{k}}. The mask loss function is defined as follows.
$${ℒ}_{m} = {\sum }_{i = 1}^{N} {\sum }_{k = 1}^{K} {h}_{i} 𝒞 ( {m}_{i}^{k} , {\hat{m}}_{i} ) \qquad ( 8 )$$
In the equation, N represents N different instances, mᵢ^{k} represents the k-th predicted ground answer mask, \hat{m}ᵢ represents its corresponding ground truth answer mask, hᵢ indicates whether to select the k-th mask resolution as the output resolution, and [symbol] represents the binary cross-entropy loss.

6. According to claim 5, the ground visual question-answering method based on dynamic dual-level visual information fusion is characterized by the specific edge loss in step 4 as follows: Edge loss is employed to measure the quality of masks. Given the output F=[f₁, . . . , fₖ] of QGDR and edge maps at different resolutions, denoted as {eᵢ¹, . . . , eᵢ^{k}}, the edge loss is defined as follows.
$${ℒ}_{e} = {\sum }_{i = 1}^{N} {\sum }_{k = 1}^{K} {h}_{i} 𝒞 ( {e}_{i}^{k} , {\hat{e}}_{i} ) \qquad ( 8 )$$
Where eᵢ^{k} represents the ground truth answer edges, which are obtained by first applying the Laplacian operator on the real ground answer mask \hat{m}ᵢ to obtain a soft edge map, and then thresholding it to convert it into a binary edge map.

7. According to claim 6, the ground visual question-answering method based on dynamic dual-level visual information fusion is characterized by the specific budget constraint and text loss in step 4 as follows: Budget constraint is employed to train QGDR. Specifically, let C denote the corresponding computational cost of the selected mask resolution, representing an expectation deviation E(C) exceeding the target deviation Cₜ during the computation of the current batch data. In such cases, a penalty is added to the model.
$${ℒ}_{b} = max ( \frac{E ( C )}{{C}_{t}} - 1 , 0 ) \qquad ( 11 )$$
The overall objective function for the ground answer branch is as follows: where λ₁ and λ₂ are balancing hyperparameters.
$${ℒ}_{t} = {ℒ}_{m} + {λ}_{1} {ℒ}_{e} + {λ}_{2} {ℒ}_{b} \qquad ( 12 )$$
Finally, the question features and visual features are combined through element-wise multiplication, and then classified using the Softmax function. Training is done using the binary cross-entropy loss function with the textual answer and PWAM.
